(19) United States
(12) Patent Application Publication
(10) Pub. No.: US 2011/0055610 A1
(43) Pub. Date: Mar. 3, 2011

(54) PROCESSOR AND CACHE CONTROL METHOD

(75) Inventor: CHUN-YU CHEN, Tainan County (TW)

(73) Assignee: HIMAX TECHNOLOGIES LIMITED, Tainan County (TW)

(21) Appl. No.: 12/550,623

(22) Filed: Aug. 31, 2009

(51) Int. Cl. G06F 1/32; G06F 12/08

(52) U.S. Cl. 713/324; 711/119; 711/E12.023

(57) ABSTRACT

A processor and a cache control method are provided herein. The processor includes a plurality of caches and a control unit. The caches are respectively controlled by a plurality of cache enable signals to be activated. The control unit generates the cache enable signals according to a power mode for selecting and accessing a subset of the caches in response to the power mode, wherein the number of the subset of the caches is determined by the power mode. Therefore, the processor can activate the caches as requirement according to the power mode for reducing power consumption of the caches.

### BACKGROUND OF THE INVENTION

1. Field of the Invention

The invention relates to a processor and a cache control method, and more particularly, to a processor and a cache control method capable of dynamically controlling cache size.

2. Description of Related Art

A microcontroller (MCU) can be seen as a computer on a single integrated circuit consisting of a processor, timers and an I/O interface etc. Generally, the microcontroller accesses program instructions and data that are needed while executing the program instructions from an external program memory, such as flash memory, through serial peripheral interface (SPI) to lower pin count of the integrated circuit if the program memory is not embedded in the integrated circuit. The time of accessing data from the program memory to the microcontroller is usually more than the time that the microcontroller executes the program instructions or process the accessed data, so that the microcontroller may be idle while the program memory is accessed.

Some parts of data in the program memory, such as program variables in common use, are often accessed while a program is executed, and these data have a good temporal locality in the program memory. In consideration of performance, a plurality of caches are usually implemented in the microcontroller for storing the parts of data routinely used, but the other parts of data may be still stored in the program memory. Memory hierarchy is set by a plurality of memories with different levels, such as the cache and the program memory. The higher the memory level is, the shorter the access time is. The time of accessing data from the cache is shorter than the time of accessing data from the program memory.

However, not all of the caches are accessed while the microcontroller executes a certain program. The caches in the microcontroller would cause a lot of power consumption, and this issue is more serious while the microcontroller is applied on power-sensitive products.

### SUMMARY OF THE INVENTION

Accordingly, an embodiment of the invention provides a processor and a cache control method that dynamically controls the number of activated caches which a microcontroller requires to access for reducing power consumption.

A processor including a plurality of caches and a control unit is provided in an embodiment of the invention. The caches are respectively activated in the control of a plurality of cache enable signals. The control unit generates the cache enable signals according to a power mode for selecting and accessing a subset of the caches in response to the power mode, wherein the number of the subset of the caches is determined by the power mode.

In an embodiment of the invention, the processor further includes a plurality of registers. Each of the registers respectively records access state information of the blocks in the corresponding cache. The control unit generates a control signal to a subset of the registers corresponding to the selected subset of the caches for resetting the access state information of the selected set of the caches.

A cache control method is provided in the invention. First, a plurality of caches are provided. The caches respectively controlled by a plurality of cache enable signals to be activated. Next, the cache enable signals are generated through a control unit according to a power mode to select and access a subset of the caches in response to the power mode, wherein the number of the subset of the caches is determined by the power mode.

In an embodiment of the cache control method, access state information of the blocks respectively in the corresponding cache is recorded. The access state information of the blocks in the selected subset of the caches is reset.

The processor and the cache control method are capable pf dynamically controlling the number of the activated caches and the cache size while the microcontroller is in different modes, instead of the traditional static cache size. Therefore, power consumption of the microcontroller can be efficiently reduced.

In order to make the features of the invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments consistent with the invention, and together with the description, serve to explain the principles of the invention.

FIG. 1 illustrates a processor according to an embodiment of the invention.

FIG. 2 illustrates the number of the activated caches under different power modes of the microcontroller according to an embodiment of the invention.

FIG. 3 is a flowchart of a cache control method according to one exemplary embodiment consistent with the invention.

### DESCRIPTION OF EMBODIMENTS

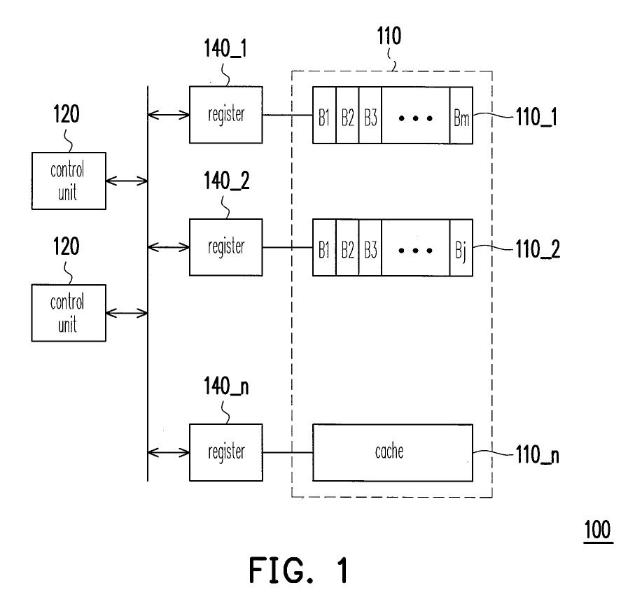

FIG. 1 illustrates a processor according to an embodiment of the invention. Referring to FIG. 1, the processor 100 includes a plurality of caches 110_1 through 110_{—}n, a control unit 120, a microcontroller 130, and a plurality of registers 140_1 through 140_{—}n, wherein the caches 110_1 through 110_{—}n are, for example, caches, which may be embedded in a integrated circuit of the microcontroller 130 or externally connected to the microcontroller 130. Each of the caches 110_1 through 110_{—}n includes a plurality of blocks respectively storing a plurality of data, such as program instructions or data that are needed while the microcontroller executes the program instructions, for the microcontroller 130 to access. For example, the cache 110_1 includes the blocks B1 through Bm, and the cache 110_2 includes the blocks B1 through Bj, wherein m and j are positive integers and can be equal or unequal. The caches 110_1 through 110_{—}n are respectively activated in the control of a plurality of cache enable signals.

Each of the caches 110_1 through 110_{—}n, temporarily stores data likely to be used again, wherein the data is a copy of the data in a backing storage device, such as a main cache. Each block in each of the caches 110_1 through 110_{—}n not only stores the data, but also records a tag for identifying an address of the data in the backing storage device. While the microcontroller 130 executes a program, the caches 110_1 through 110_{—}n are first checked whether the needed data is stored in or not according to the tag. If the needed data is stored in one of the caches 110_1 through 110_{—}n, it is known as “hit”. On the contrary, if the needed data can not be found in any one of the caches 110_1 through 110_{—}n, it is known as “miss”, and some data in the caches 110_1 through 110_{—}n should be ejected in order to make room for storing the needed data accessed from the backing storage device. Generally, the replacement policy refers access state information of the blocks in the caches 110_1 through 110_{—}n to replace least recently used data with the needed data. Therefore, in the embodiment of the invention, each of the register 140_1 through 140_{—}n respectively records the access state information of the blocks in the corresponding cache.

Generally, the microcontroller 130 may be set in different power modes according to a work-load of the microcontroller 130. For example, with the decrease of the amount of computation, the microcontroller 130 may be set in power-saving mode for reducing power consumption. The microcontroller 130 is often used in automatically controlled products or devices, and executes routine programs corresponding to the power mode. The needed data corresponding to these programs are likely stored in some caches. That is to say not all of the caches 110_1 through 110_{—}n should be activated. In the embodiment of the invention, the control unit 120 electrically connected to the microcontroller 130 and these caches 110_1 through 110_{—}n generates the cache enable signals to the caches 110_1 through 110_{—}n according to the power mode of the microcontroller 130. In such way, the control unit 120 selects and accesses a subset of the caches 110_1 through 110_{—}n in response to the power mode. Namely, the number of the subset of the caches is determined by the power mode for dynamically control the number of the activated caches and the cache size as requirement for reducing power consumption.

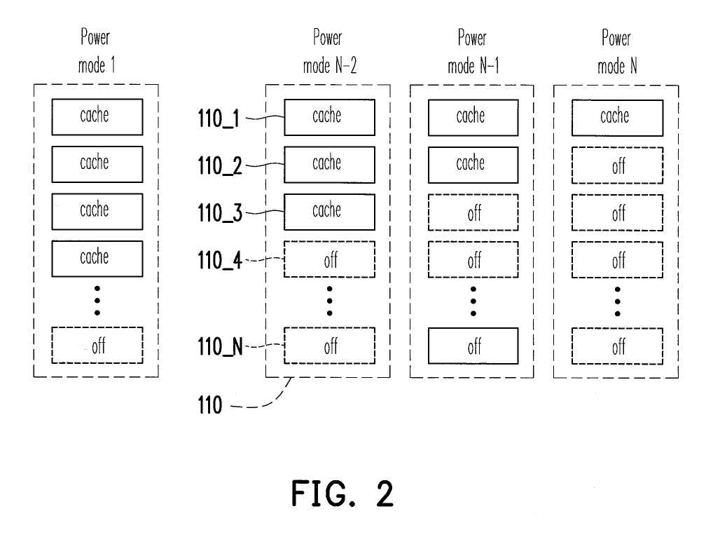

FIG. 2 illustrates the number of the activated caches under different power modes of the microcontroller 130 according to an embodiment of invention. Referring to FIG. 2, the cache drawn with the real-line block among the caches 110_1 through 110_{—}n represents that the cache is activated by the corresponding cache enable signal outputted from the control unit 120, and the cache drawn with the dotted-line block among the caches 110_1 through 110_{—}n represents that the cache is not activated. The microcontroller 130 accesses data from the activated cache for executing the programs. For example, all of the caches 110_1 through 110_{—}n are activated when the microcontroller 130 is in the power mode 1 for best system performance. Besides, only one of the cache caches 110_1 through 110_{—}n, such as the cache 110_1, is activated when the microcontroller 130 is in the power mode N for saving the most power and the others are not activated. The number of the activated caches corresponding to the different power modes should be properly designed according to the amount of the data that are needed while the microcontroller 130 executes the programs corresponding to the power mode, so the invention is not limited thereto. In the embodiment of the invention, a state machine can be implemented in the control unit 120 for selecting the proper caches while the power modes are switched.

Take the power mode N-2 and the power mode N as an example. Referring to FIG. 1 and FIG. 2, the caches 110_1 through 110_3 are activated by the corresponding cache enable signals from the control unit 120 while the microcontroller 130 is in the power mode N-2 and executes the programs corresponding to the power mode N-2. In the meanwhile, the registers 140_1 through 140_3 respectively record the access state information of the blocks in the corresponding caches 110_1 through 110_3, such as counts of “hit” or “miss” which can be referred to increase the performance of the replacement policy. Under the power mode N-2, the total cache size is a sum of the cache size of the activated caches 110_1 through 110_3. When the microcontroller 130 is switched to be in the power mode N, the cache 110_1 is still activated by the corresponding cache enable signal, but the caches 110_2 and 110_3 are not activated. Since the data that are needed while executing the programs corresponding to the power mode N may be partly or completely different to the data that are needed while executing the programs corresponding to the power mode N-2, the control unit 120 generates a control signal to the subset (i.e. the register 140_1) of the registers 140_1 through 140_{—}n corresponding to the selected subset (i.e. the cache 110_1) of the caches 110_1 through 110_{—}n for resetting the access state information of the selected subset of the caches 110_1 through 110_{—}n and ensuring the microcontroller 130 can normally operate.

In the embodiment, the selected cache caches in different power modes are exemplary, such as the selected cache caches 110_1 through 110_3 in the power mode N-2 and the selected cache 110_1 in the power mode N, but it does not limit to the scope of the prevent invention. In other embodiment, the switch operation between different power modes is similar to the switch operation between the power mode N-2 and the power mode N in the said embodiment. The processor 100 dynamically controls the number of the activate caches and the cache size in response to the power mode of the microcontroller for reducing power consumption.

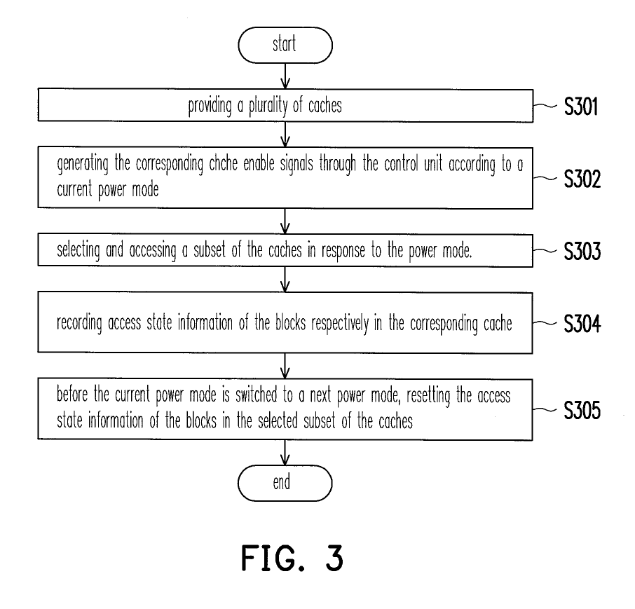

FIG. 3 is a flowchart of a cache control method according to one exemplary embodiment consistent with the invention. Referring to FIG. 1 through FIG. 3, the cache control method includes the following steps. First,, the plurality of cache caches 110 is provided in step S301. Secondly, the corresponding cache enable signals are generated through the control unit 120 according to a current power mode of the microcontroller 130 in step S302. Then, a subset of the cache caches 110 is selected and accessed in response to the power mode in step S303. Thereafter, access state information of the blocks in the corresponding cache is respectively recorded in step S304. Before the current power mode is switched to a next power mode, the access state information of the blocks in the selected subset of the cache caches 110 is reset in step S305. For the method, enough teaching, suggestion, and implementation illustration are obtained from the above embodiments, so it is not described again.

To sum up, the exemplary embodiment consistent with the invention provides a processor and a cache control method thereof capable of dynamically controlling the number of the activated caches and the cache size while the microcontroller is in different modes. The control unit generates cache enable signals to manage the cache caches size in response to the power mode, so that the subset of the cache caches corresponding to other different power mode is optional designed for power requirement. Therefore, the cache size in the processor is dynamically controlled for reducing power consumption.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A processor, comprising:
a plurality of caches, respectively controlled by cache enable signals to be activated; and
a control unit, generating the cache enable signals according to a power mode of the processor, for selecting and accessing a subset of the caches in response to the power mode, wherein the number of the subset of the caches is determined by the power mode.

2. The processor as claimed in claim 1, further comprising:
a plurality of registers, each of the registers respectively recording access state information of the blocks in the corresponding cache, wherein the control unit further generates a control signal to a subset of the registers corresponding to the selected subset of the caches for resetting the access state information of the selected set of the caches.

3. A cache control method, comprising:
providing a plurality of caches respectively controlled by a plurality of cache enable signals to be activated; and
generating the cache enable signals through a control unit according to a power mode to select and access a subset of the caches in response to the power mode, wherein the number of the subset of the caches is determined by the power mode.

4. The method as claimed in claim 3, further comprising:
recording access state information of the blocks respectively in the corresponding cache; and
resetting the access state information of the blocks in the selected subset of the caches.
